(19) United States
(12) Patent Application Publication
(10) Pub. No.: US 2004/0172525 A1
(43) Pub. Date: Sep. 2, 2004

(54) Electronic device and method for processing compressed program code

(76) Inventor: Arnaud Sebastien Christophe Rosay, Le Mans (FR)

Correspondence Address: Corporate Patent Counsel, Philips Electronics North America Corporation, P O Box 3001, Briarcliff Manor, NY, 10510, US

(21) Appl. No.: 10/479,553

(22) PCT Filed: Jun. 4, 2002
(86) PCT No.: PCT/IB02/02058

(30) Foreign Application Priority Data
Jun. 6, 2001 (FR) 01/07387

(51) Int. Cl. G06F 9/44

(52) U.S. Cl. 712/241

(57) ABSTRACT

The present invention relates to an electronic device utilizing code compression, which device comprises a pipeline processor (25), a branching unit (26) which allows the address of the next instruction to be anticipated, a code decompression unit (27), and a memory (28), a new set of compressed instructions being defined for the combined processor (25), branching unit (26) and decompression unit (27). The decompression unit (27) is suitable for sending two signals for the start and end of a loop to the branching unit (26) by decoding the start-of-loop and end-of-loop labels which have been introduced into the new set of instructions. The branching unit (26) processes these two signals.

The present invention also relates to a management method for a processor of this kind.

The present invention relates to an electronic device utilizing code compression, which device comprises a pipeline processor, and a management method for a processor of this kind.

The designers of complex on-board electric devices often need the processing power of RISC (Reduced Instruction Set Computer) processors in order to implement devices with high-level characteristics and performance, and a fixed cost that is as low as possible. In fact, this is hard to implement. On-board RISC processors of this kind, integrated into an Application-Specific Integrated Circuit (ASIC), for example, display limiting characteristics with regard to their storage capacity, and especially their code storage capacity. A code compression method allows, in fact, the storage capacity for an on-board application to be reduced.

The IBM code compression device called “CodePack”, as described in the reference documents [1] and [2] at the end of this description, is an example of the implementation of a device of this type.

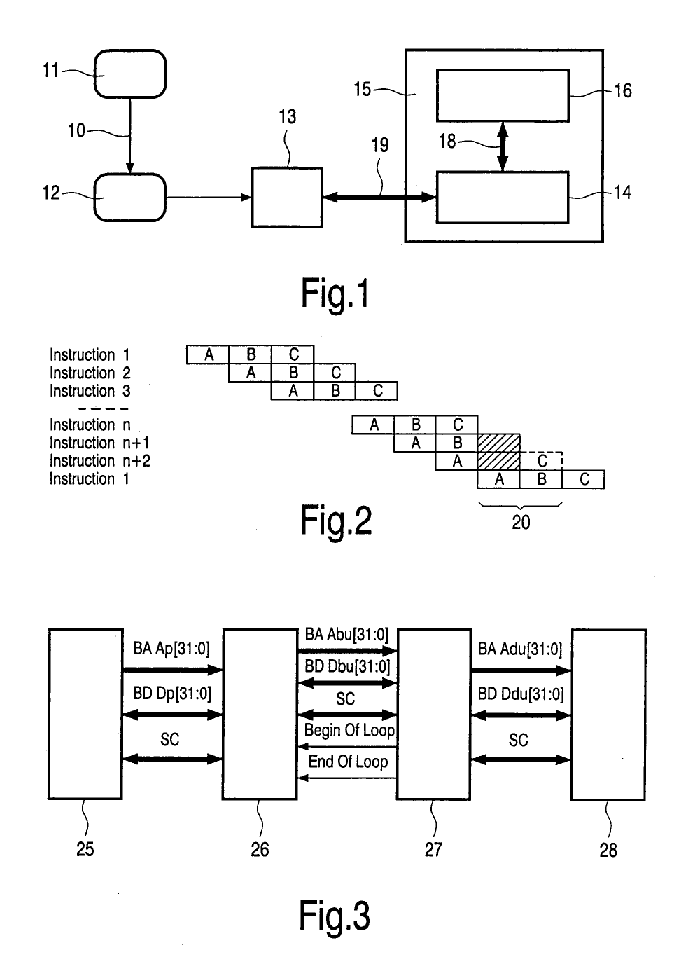

A code compression technique, as described in reference document [2] and as illustrated in FIG. 1, generally comprises:

on the one hand, utilizing a software program 10 for translating a source code 11 into compressed instructions 12 which are placed in a program memory 13,

on the other hand, decompressing the instructions on the fly in the application-specific integrated circuit 15, in a decompression unit 14 situated between a RISC processor 16 and the memory 13, the buses 18 and 19 being an internal bus and an external bus respectively.

A compression technique of this kind displays a major disadvantage, however: there is a loss of processing power due to the fact that the stream of compressed and then decompressed instructions is not identical to what it would have been without these compression and decompression steps. The reference document [2] thus predicts a loss of power capable of running to 10%.

On the other hand, when a RISC processor is used, its architecture can also affect the performance of the device. Most RISC processors in fact possess a pipeline with a number of stages depending on the design of the processor. This applies to the ARM7 processors of the company Advance Risc Machine Ltd and the R3000 processors of the company MIPS, for example. The first stage of all the pipeline processors is a stage for fetching. In this stage, the processor activates its address bus in order to obtain an instruction on its data bus. In processors of this kind, each program loop that terminates in a conditional branch instruction gives rise to a large time loss: in fact, several instructions, the number of which depends on the extent of the pipeline, are called after a conditional branch and are not executed when a branch to a start of loop takes place. The pipeline must then be emptied and filled again from the start of the loop. The pipeline is thus emptied and refilled at each of the loop-backs to the start of a loop, which has a negative impact on the performance of the processor.

FIG. 2 shows a disadvantage of this kind during the execution of a loop of n instructions by a pipeline with three stages, the n^{th} instruction being the conditional branch instruction. These three stages are respectively a stage for fetching (task A), a stage for decoding (task B) and a stage for executing (task C). In this example, each time the loop is executed, two cycles, bearing the reference 20, corresponding to instruction calls outside the loop (cycles n+1 and n+2) are lost, which results in a reduction in the processing power of the processor. The cycles shown hatched correspond to emptying cycles. If it is assumed that this loop is executed 100 times and that the size of the loop is 20 instructions, 200 out of 2000 cycles are then lost, which represents a loss of about 10%.

In order to resolve this problem, as described in the reference document [3], certain complex microprocessors incorporate a branching unit which allows the address of the next call to be anticipated. But, in the field of on-board electronic devices, the processors utilized traditionally do not possess a unit of this kind, since in this field efforts are made to set the sights as accurately as possible in terms of cost and autonomy.

The object of the present invention is to offset the disadvantages defined above.

The present invention relates to an electronic device utilizing code compression, which comprises a pipeline processor, a branching unit which allows the address of the next instruction to be anticipated, a code decompression unit, and a memory, a new set of compressed instructions being defined for the combined processor, branching unit and decompression unit, characterized in that the decompression unit is suitable for sending two signals for the start and end of a loop to the branching unit by decoding the start of loop and end-of-loop labels which have been introduced into the new set of instructions and in that the branching unit is suitable for processing these two signals.

The branching unit, which operates transparently when there are no start-of-loop or end-of-loop signals, carries out copying of the incoming signals to the outgoing signals in this case.

The present invention also relates to a management method for a pipeline processor in a compressed program loop which is terminated by a conditional branch instruction, characterized in that it comprises the following steps:

start-of-loop and end-of-loop labels are introduced into the first and last instructions of the loop,

the start-of-loop address is stored when the start-of-loop label is encountered,

when the end-of-loop label is encountered, in the case of loop-back, the instruction situated at the start-of-loop address is taken into account.

The solution presented by the invention can be applied to most RISC processors utilizing a compression technique. It allows the execution time to be reduced and offers a good compromise between code size and processing power.

The device according to the invention can advantageously be utilized in the field of portable devices, especially in the field of telecommunications by means of mobile phones. On the one hand, it allows an increase in the size of memory to be avoided when new features are added, and on other hand, it allows a very competitive cost to be achieved.

These and other aspects of the invention are apparent from and will be elucidated, by way of non-limiting example, with reference to the embodiment(s) described hereinafter.

In the drawings:

FIG. 1 shows a code compression/decompression device of the known type.

FIG. 2 shows the behavior of a pipeline with three stages during the execution of a loop of n instructions, the n^{th} instruction being a conditional branch instruction.

FIG. 3 shows the device according to the invention.

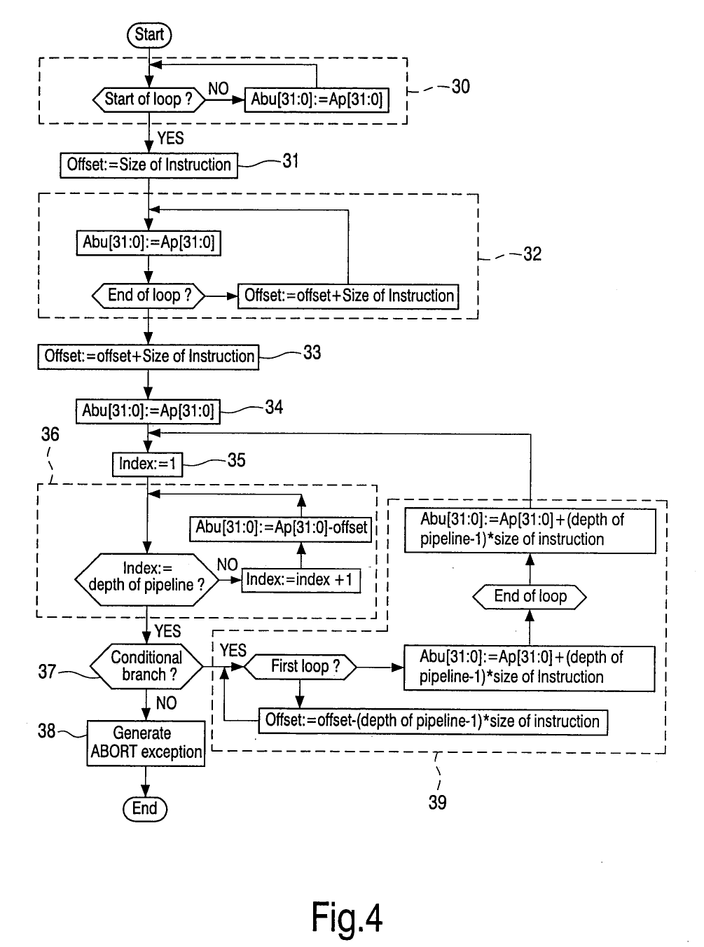

FIG. 4 shows a flowchart of an example of operation of the device according to the invention.

As illustrated in FIG. 3, the device according to the invention is a device utilizing code compression comprising a pipeline processor 25, such as an on-board processor, a branching unit 26, a decompression unit 27 modified in order to reduce the number of times that the pipeline is emptied, and a memory 28. Shown in this Figure are the address buses BA, the data buses BD, the control signals SC, and two signals that are specific to the invention, BeginOfLoop and EndOfLoop.

The branching unit 26 allows the correct address to be anticipated in order to avoid emptying the pipeline.

New start-of-loop and end-of-loop labels are introduced into the first and last instructions of each loop. The start-of-loop address is thus stored when the start-of-loop label is encountered. When the end-of-loop label is encountered, if there is loop-back, the instruction taken into account is not the instruction situated at the address following the loop but at the start-of-loop address. It is therefore no longer necessary to empty the pipeline to execute the loop again. All the emptyings of the pipeline are thus avoided except for that existing at the end of the loop.

In the device according to the invention, the branching unit 26 is arranged outside the processor, which allows the operation of the processor to be improved, and to compensate for the impact, in terms of performance, of the decompression unit 27.

In the device according to the invention, as illustrated in this FIG. 3, an application-specific integrated circuit (ASIC) can incorporate:

either all the components 25, 26, 27 and 28,

or all the components, except the memory 28 which remains external,

or all the components except the processor 25,

or the branching unit 26 and the decompression unit 27.

An embodiment which corresponds to the device illustrated in FIG. 3 features a processor 25 of type ARM7TDMI, which is widely utilized for on-board applications.

The decompression unit 27 allows the two “BeginOfLoop” and “EndOfLoop” signals to be generated towards the branching unit 26, by decoding the two start-of-loop and end-of-loop labels introduced into the set of compressed instructions. The control signals SC are the signals allowing access to the memory, the signal ABORT which allows an exception to be generated on the processor, the signal NEXEC, which indicates that an instruction in the execution stage is not in the process of being executed, and the signal nOPC, which indicates an operating code call.

With regard to memory calls that do not correspond to fetching an operating code, the branching unit is transparent, which comprises copying the address and data buses, represented by the following equations: Abu[31:0]=Ap[31:0] and Dbu[31:0]=Dp[31:0].

An example of the operation of the branching unit 26 is therefore illustrated in the flowchart in FIG. 4, which shows successively:

a start-of-loop test (reference 30),

the initialization of an initial variable designated “offset” on the size of the instruction (reference 31),

an end-of-loop test (reference 32),

the modification of the variable offset (reference 33),

the copying of the bus (reference 34),

the initialization of a second variable designated “index” (reference 35),

a test of the time when the end-of-loop instruction is in the execution stage of the processor (reference 36),

an executed conditional branch test (reference 37),

the generation of the ABORT exception (reference 38),

a measure to make the pipeline phenomenon transparent and to avoid any emptying (reference 39).

An ABORT exception is generated in order to exit from the loop, when the conditional branch is not executed. This exception changes its return address in order to resume execution of the code correctly.

References:

[1] “PowerPC adopts Code Compression” by Jim Turley (Microdesign Resources, 26 Oct. 1998, Microprocessor Report).

[2] “CodePack™: Code Compression for PowerPC™ Processors” by Mark Game and Alan Booker (Internet site: www.chips.ibm.com/products/powerpc/corer/cd pack-wp.pdf; version 1.0).

[3] “PowerPC 603e™ RISC Microprocessor Technical Summary” (MPR603TSU-04, MPC603E/D, Motorola Inc., 1995, pages 1-32).

1. An electronic device utilizing code compression, which device comprises a pipeline processor (25), a branching unit (26) which allows the address of the next instruction to be anticipated, a code decompression unit (27), and a memory (28), a new set of compressed instructions being defined for the combined processor (25), branching unit (26) and decompression unit (27), characterized in that the decompression unit (27) is suitable for sending two signals for the start and end of a loop (BeginOfLoop, EndOfLoop) to the branching unit (26) by decoding the start-of-loop and end-of-loop labels which have been introduced into the new set of compressed instructions, and in that the branching unit (26) is suitable for processing these two signals.

2. A device as claimed in claim 1, in which the branching unit (26) operates transparently when there are no start-of-loop or end-of-loop signals, and therefore carries out copying of the incoming signals to the outgoing signals in this case.

3. A device as claimed in claim 1 comprising an application-specific integrated circuit which incorporates the processor (25), the branching and decompression units (26, 27) and the memory (28).

4. A device as claimed in claim 1 comprising an application-specific integrated circuit which integrates the processor (25) with the branching and decompression units (26, 27).

5. A device as claimed in claim 1 comprising an application-specific integrated circuit which integrates the branching and decompression units (26, 27) with the memory (28).

6. A device as claimed in claim 1 comprising an application-specific integrated circuit which integrates the branching and decompression units (26, 27).

7. A device as claimed in any of the foregoing claims which is an on-board device.

8. A management method for a pipeline processor in a compressed program loop which is terminated by a conditional branch instruction, characterized in that the method comprises the following steps:
start-of-loop and end-of-loop labels are introduced into the first and last instructions of the loop,
the start-of-loop address is stored when the start-of-loop label is encountered,
when the end-of-loop label is encountered, in the case of loop-back, the instruction situated at the start-of-loop address is taken into account.

9. A method as claimed in claim 8, in which the pipeline processor is a RISC processor.
